(19) United States
(12) Patent Application Publication
(10) Pub. No.: US 2005/0225078 A1
(43) Pub. Date: Oct. 13, 2005

(54) Method for identification and registration of received items before storage in a factory stock

(75) Inventors: Kurt Byskov, Aarhus C (DK); Henning Maerkedahl, Hinnerup (DK)

Correspondence Address: NIXON PEABODY, LLP, 401 9TH STREET, NW, SUITE 900, WASHINGTON, DC, 20004-2128, US

(73) Assignee: TraceXpert AS, Aarhus C (DK)

(21) Appl. No.: 10/501,958

(22) PCT Filed: Jan. 14, 2003
(86) PCT No.: PCT/DK03/00019

§ 371 Date: Jul. 21, 2004

(30) Foreign Application Priority Data
Jan. 21, 2002 (DK) PA 2002 00104

(51) Int. Cl. B42D 15/00

(52) U.S. Cl. 283/81

(57) ABSTRACT

The present invention relates to the inspection and registration of containers with identical items, for example electronic components on reels, which are received at a factory before the containers are moved to the factory stock.

The present invention relates to identification and registration of items that are received at a factory before the items are moved to the factory stock. The invention is applicable to electronic components received on reels, but not limited to these items.

### BACKGROUND OF THE INVENTION

When items are delivered to the receiving section of a production company, it is important that the items are registered in the database of the company before being put on stock for later consumption. This is especially valid in companies where a high amount of different components are used, as in electronic production factories.

The registration includes the right item type and eventually other relevant associated data, for example identification of the supplier, a suppliers lot number for the item, or the number of items in a container, for example a reel with electronic components. Also interesting to register may be the registration date and the order note identification, among others.

It is common for the supplier to label the items before delivery to the factory with a general ID (identification of the item) and sometimes with a serial number, for example on the container. At the factory site, this serial number may be stored in a database together with other associated data, for example electrical or other physical properties obtained during a quality control measurement. The general ID then identifies the item, and the associated data are used by the stock control systems when the items are to be consumed for production in the factory.

However, it is common to receive items with equal specifications from different suppliers. In order to avoid handling of different general ID's for the same type of item during a production process, it is possible to equip the received items with a label provided at the factory receiving site in order to assure a uniform ID for equal products. However, during such a manual labelling process, mistakes may occur such that inappropriate labels are placed on the item containers. This is especially a problem in industries like electronic industries as will become more apparent in the following.

In some industrial areas, like for the production of electronic products, the items to be used in the production may have no clear recognisable appearance. For certain similar electronic components, especially small components, the differences may hardly be recognised by the human eye. Often, the only way to distinguish different items is a label with a bar code on the envelopment of the components, for example a reel with electronic components on a tape.

The identification of the type of electronic components is also difficult, because identical components may have a variety of different labels dependent on the supplier that is used. Furthermore, it has to be acknowledged that the amount of electronic stock items may be huge (easily up to 50,000 different types of items), which makes the correct classification complicated and which may lead to false type association of the received item when done manually. The risk for wrong labelling is high especially due to the high amounts of items that are received at the factory, and because the shape of many items are very similar.

The consequence is incorrect information in the stock control system, and thus unexpected stops in the production lines because of lack of items. Another consequence may be erroneous products because wrong components have been used in the production. If some of these erroneous products are delivered to the end customer, it can be very difficult and expensive to correct the error.

It is therefore the purpose of the invention to improve identification and registration procedures in factories, especially factories of electronic products.

### DESCRIPTION OF THE INVENTION

This purpose is achieved by the following method for identification and registration of a container received at a factory from a supplier before the container is moved to the factory stock. It is assumed that the container contains a number of identical items, and that the container has a general label attached with a general ID that is indicative of the type of the items in the container. This general ID may be a bar code on a bar code label on the container.

The method comprises identifying the type of the items in the container from the general ID of the container. This identification of the type may be directly achieved through the reading of the general ID, if the general ID contains such information. It may, for example, also be achieved by comparing the general ID with a list, for example in a computer database.

Different containers may contain similar items and, therefore, the containers may be equipped with identical general labels. This makes tracing of specific containers, for example containers that contain defect items, in the factory difficult. Therefore, according to the invention, individual labels with individual IDs are provided for individual labelling of each container. After labelling of the containers, the individual IDs are readable from the individual labels.

The individual ID of each container has now to be stored in a database with the right item type associated to each individual ID. Therefore, the individual ID is read from the individual label simultaneously with the reading of the general ID from the general label. This minimises the risk for a wrong labelling. When the individual ID and the general ID have been read, the individual ID is associated with the type of item, where the latter has been derived from the general ID. Finally, a data record containing the individual ID and the associated type of item is stored together in a database.

By using the method according to the invention, the risk for mistakes in the database is minimised because it prevents a wrong labelling of a container. A wrong labelling of a container may have severe impact on the production. For example, the end products may have defects.

The labels that are provided may be taken randomly from a box or role of labels. In this case, the type of the items in the container may be determined during the simultaneous reading.

However, in some certain situations, it may be of advantage to provide specific individual labels having specific information, for example indicating the type of item in the container, the supplier, the date of registration, the production line where this item should be used, and further relevant data. This specific information may also be written in text on the label, such that a technician can identify the item quickly without bar code reader. In order to provide this kind of specific individual labels, the general label may be read initially and the type of item may be determined, after which a specific individual label is printed. The simultaneous reading of the general ID and the individual ID afterwards assures, that the right label indeed has been placed on the container. A wrong labelling would be discovered by the system at this stage and induce an error signal. This check is important in case that a number of labels have been printed together for manual placement on a number of containers, a situation chosen by the technician in the receiving section in order to save labour and time.

The method according to the invention is simple and very reliable and minimises errors introduced by humans working in the receiving section of the factory. Further advantages will become apparent in the following.

In another embodiment of the invention, the general label also contains readable data indicative of an identification of the supplier. This is very helpful in case that defect items have been observed. The identification of the supplier in connection with these defect items may show, whether this supplier provides a large number of defect items, which may lead to a decision to use a different supplier for this type of item. Also, the general label may indicate the supplier's lot number for the item. This is a helpful information if the supplier realises, that a number of sold containers, for example boxes or reels with electronic components, have unsatisfactory items, and calls back those specific containers. Also, if the factory staff realises that components with a specific lot number are unsatisfactory, they are able to identify those containers that have this specific lot number, and even those products that already have been produced with components from containers with this specific lot number.

For the factory, it may be of help to know and store the number of the items in the container, why this information as well may be indicated on the general label. This indication may be additional data besides the general ID, or it may be taken from a table where these data are linked to the general ID. In certain circumstances, such kind of additional data is specified on a delivery note. Though not all information is available from all suppliers, the supplier's product type is generally indicated as a minimum information.

In a further embodiment of the invention, the method also comprises associating to the specific ID the registration date or the order note identification for the container. Thus, the stored data record may comprise the associated registration date and the order note identification as well.

Preferably, the general labels and the individual labels are bar code labels that can be read with a bar code reader. However, it is also possible, that the labels used in connection with the invention are electronic radio frequency tags. This would imply a very fast registration procedure. Also, the possibility of programming such a tag opens the possibility for achieving the advantages of the inventions not only by adding an individual label but also by reprogramming the general tag to contain the general ID as well as the individual ID. Finally, the invention does not exclude manual intervention from an operator, who may enter data to the data register through a key-board.

In some cases, the received products may be stored in the stock but not yet allowed for being used in the production process. To take this into account, the invention foresees that the specific record also contains a ready-for-use-mark. The ready-for-use-mark may be either in a positive or in a negative state. Thus, the items from the container are only allowed for use in a production process if the ready-for-use-mark is in a positive state.

The requirements for the positive state are configurable and dependent on how much information gets determined and recorded. For example, the positive state may be dependent on a time interval passed from the registration date. Thus, containers with items may be placed on stock but first used in the production after a certain time delay, for example after a change of the production line. It may also be such that the first products in a production process require items with more precise specifications than later products, why those items with less precise specifications are first allowed for use at a later time. Also, the positive state may be dependent on a technical test of the electrical or other physical properties of one or several of the items in the container.

It may be the case that the factory receives similar items from different suppliers. The suppliers may choose different type indications on their labels. In this case, it is appropriate for the production, that these similar items are recorded in the database as being of the same sort. This is taken into account by the invention in that the method further comprises storing in the database an item classification scheme with an item classification for each sort of item to be used in production processes in the factory. The item classification is indicative of electrical or other physical requirements for the sort of items. This classification scheme is then used for checking whether the identified type of the items meets the requirements in connection with at least one of the classifications.

Thus, when a container with items is received, the type is identified and the associated specifications are compared with classifications in the classification scheme. Once a merge is found, the individual ID is associated with this classified sort of items. The advantage of this may be illustrated with the following.

For example, the specifications for one sort of items to be used in a production process may allow relatively large tolerances, for instance electronic tolerances. Thus a number of different types of items—where the type is dependent on the tolerances—may be used as one item sort for this production, namely those types, where the specifications have smaller tolerances than required for the sort to be used. In this case, it is convenient to translate the different types of items into one single sort to be used for production, because all types fulfil the requirements for this sort. Thus, for each container, the individual ID is associated with at least one of the classification and a corresponding indication is stores in the record. Effectively, the original type of item is translated into a certain sort of item, where the sort of item is according to a factory specific classification.

The usefulness of the classification scheme may also be illustrated by another example. In this example, the same type attribute is given for items in a number of containers from different suppliers. Despite variations in the quality from different suppliers, the same type attribute may be used due to allowed large tolerances in the specifications for this type. However, due to the allowed large tolerances, it may be convenient to index those containers with items having small tolerances differently from those containers where the items have large tolerances. How this indexing or sort attributing is performed is determined by the classification scheme in the database.

For example, the items of interest may be electronic resistors of a specific type, say 10 ohms with at most 5% tolerance. One supplier may deliver resistors with 5% tolerance, while another supplier may provide these resistors with a 2% tolerance. Even though they are delivered as being of the same type, the latter may be of greater value for the factory in one other specific production line. Thus the resistors from the first supplier satisfy some item classifications from the classification scheme, namely resistors with 10 ohms resistance and max. 5% tolerance, why these resistors are attributed to one sort of resistors. The resistors from the second supplier satisfy the former item classification and also another item classification, namely resistors with 10 ohms and at most 2% tolerance. In a production, where resistors with 10 ohms and at most 5% tolerance may be used, the resistors of both suppliers may be used, why for the other specific production line, only the 2% tolerance resistors may be used. From this example, it should be apparent that it is very valuable for the factory to sort the resistors from the two suppliers differently though the two sorts of resistors originally are of the same type.

The determination of these tolerances may be achieved by measurement at the factory site or at the supplier site.

It has turned out, that it is of great advantage if the reading of the individual ID from the individual label and the simultaneous reading of the general ID from the general label is performed by imaging with a digital imaging device, for example a flat bed scanner or a CCD (charge coupled device) camera. By image processing of the digital image, bar codes, text, and logos may be recorded and used for data recognition and subsequently stored. Especially the logo may be used for recognition of the supplier in case that no indication for the supplier can be achieved by using the general ID.

It has to be acknowledged that the data recording in a method according to the invention is suitable in connection with so-called ERP (Enterprise resource planning) systems like SAP® to which data may be copied or retrieved, for example the item type on the basis of the order note as received by the receiving section.

The invention will be explained in more detail in the following with reference to the drawings.

### BRIEF DESCRIPTION OF THE DRAWINGS

FIG. 1 is a flow diagram of the method according to the invention,

FIG. 2 is a flow diagram of an alternative embodiment of the invention,

FIG. 3 is an example of a record table according to the invention.

### DETAILED DESCRIPTION OF THE INVENTION

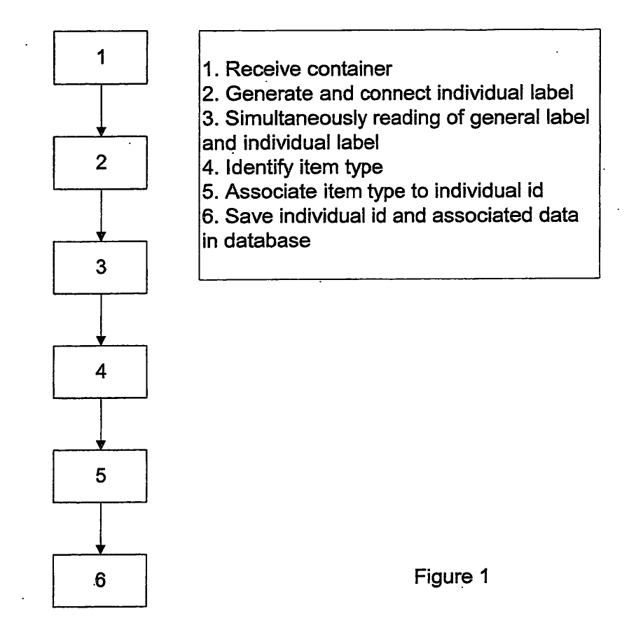

The method according to the invention is illustrated in FIG. 1. After having received 1 a container, an individual label 2 is provided with an individual ID, for example a unique serial number for the container, and connected to the container. This individual label may be provided by printing a bar code label on a printer in the incoming area of the receiving section of the factory. The individual ID is read 3 from the individual label simultaneously with the reading of the general ID, which also could be a serial number, from the general label. The type of the item is identified 4 from the general ID, for example based on a conversion table, such that the type can be associated 5 with the individual ID and be stored 6 in the database in a data record. After this, the item is moved to the factory stock.

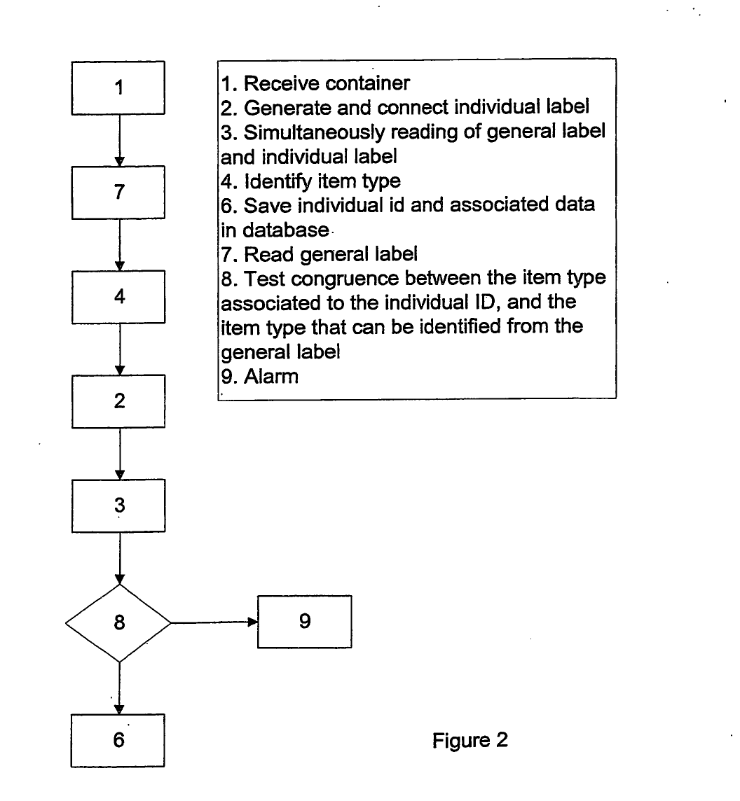

The identification 4 of the type of the item may be achieved before the simultaneous reading as illustrated in FIG. 2. In this case, after having received 1 the container, the general label is read 7, and the type of item is identified 4 therefrom and recorded for later use. Then, an individual label is provided 2 with indications of the type of item and connected, for example by manually gluing, to the container with items, for example a reel with identical electronic components. The individual ID is read 3 from the individual label simultaneously with the reading of the general ID from the general label. After having controlled 8 the congruence between the associated individual label and the earlier type identification, the item type is then associated to the individual ID and stored 6 in the database in a data record. If the congruence cannot be verified, an alarm 9 is given.

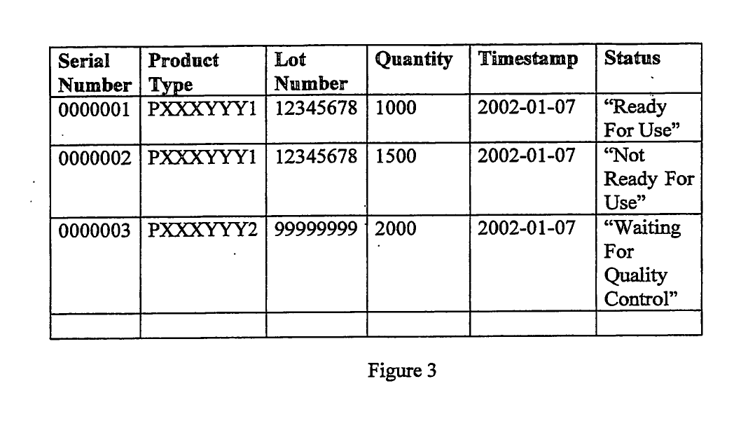

FIG. 3 shows an example of a database table that holds properties of stock items. The first record (serial number 0000001) contains data for a record that has passed the registration system. Apart from the serial number 0000001 as an individual ID, the record contains the type of item, a lot number from the supplier, the original and maybe actual quantity of items in the container, the date of the registration and a ready-for-use-mark, which in this case is positive. Likewise data are found for the next two records. However, the second record (serial number 000002) has no positive status for the ready-for-use-mark, for example because it contains data for a record that has not been verified in the registration system. The third record (serial number 000003) contains data for a record that has passed the registration system, but which still has not received a positive ready-for-use-mark, because it has not yet passed the quality control system.

1. Method for identification and registration of a container received at a factory from a supplier before said container is moved to the factory stock, said container containing a number of identical items, said container having a general label attached with a general ID, said general ID being indicative of the type of said items in said container, the method comprising
using said general ID of said container for identifying the type of said items in said container,
providing an individual label with an individual ID for said container, and attaching said individual label to said container, said individual ID being readable from said individual label,
simultaneously reading said individual ID from said individual label and reading said general ID from said general label,
associating said individual ID with said type of items, and
storing in a database a data record containing said specific ID and said associated type of said items.

2. Method according to claim 1, wherein said general label also contains readable data indicative of
an identification of said supplier,
a supplier's lot number for said item,
the quantity of said number of items in said container, for example a box or reel with electronic components.

3. Method according to claim 1 wherein
that said method also comprises associating to said specific ID a registration date or an order note identification for the container and
that said data record also contains said associated registration date and said order note identification.

4. Method according to claim 1, wherein said general label is
a bar code label or
an electronic radio frequency tag.

5. Method according to claim 1, wherein said specific record also contains a ready-for-use-mark, said ready-for-use-mark being in a positive or negative state, where said items from said container are only allowed for use in a production process if said ready-for-use-mark is in a positive state.

6. Method according to claim 5, wherein that the positive state of said ready-for-use-mark is dependent on
a time interval passed from the registration date or
a technical test of the electrical or other physical properties of at least one of said items in said container.

7. Method according to claim 1, wherein said method further comprises
storing in said database an item classification scheme with an item classification for each sort of item to be used in production processes in said factory, said item classification being indicative of electrical or other physical requirements for said sort of items,
checking whether said identified type of said items meets the requirements in connection with at least one of said classifications,
and in the affirmative associating said individual ID with said at least one of said classifications.

8. Method according to claim 1, wherein said simultaneous reading of said individual ID from said individual label and reading said general ID from said general label comprises reading a digital image with a digital imaging device and image processing of said digital image in order to recognise and store bar codes, text, and logos.

9. Method according to claim 2 wherein
that said method also comprises associating to said specific ID a registration date or an order note identification for the container and
that said data record also contains said associated registration date and said order note identification.

10. Method according to claim 3, wherein said general label is
a bar code label or
an electronic radio frequency tag.

11. Method according to claim 4, wherein said specific record also contains a ready-for-use-mark, said ready-for-use-mark being in a positive or negative state, where said items from said container are only allowed for use in a production process if said ready-for-use-mark is in a positive state.

12. Method according to claim 6, wherein said method further comprises
storing in said database an item classification scheme with an item classification for each sort of item to be used in production processes in said factory, said item classification being indicative of electrical or other physical requirements for said sort of items,
checking whether said identified type of said items meets the requirements in connection with at least one of said classifications,
and in the affirmative associating said individual ID with said at least one of said classifications.

13. Method according to claim 7, wherein said simultaneous reading of said individual ID from said individual label and reading said general ID from said general label comprises reading a digital image with a digital imaging device and image processing of said digital image in order to recognise and store bar codes, text, and logos.
